(19) United States
(12) Patent Application Publication
(10) Pub. No.: US 2005/0075857 A1
(43) Pub. Date: Apr. 7, 2005

(54) Method and system for dynamically translating closed captions

(76) Inventors: Albert F. Elcock, Havertown, PA (US); William J. Garrison, Warminster, PA (US)

Correspondence Address: STEVEN L. NICHOLS;RADER, FISHMAN & GRAVER PLLC, 10653 S. RIVER FRONT PARKWAY, SUITE 150, SOUTH JORDAN, UT, 84095, US

(21) Appl. No.: 10/678,717

(22) Filed: Oct. 2, 2003

(51) Int. Cl. G06F 17/28; G10L 21/00

(52) U.S. Cl. 704/2; 704/277

(57) ABSTRACT

A system and a method for translating textual data in a media signal includes receiving a media signal containing textual data of a first language, selectively transmitting the media signal to a language translation module, translating the textual data to a second language, and transmitting the translated textual data to a display device to be displayed.

### FIELD

The present method and system relate to delivering closed captions to a television. More particularly, the present method and system provides for translating closed caption language in response to a user request.

### BACKGROUND

In addition to the video and audio program portions of a television program, television signals include auxiliary information. An analog television signal such as a national television system committee (NTSC) standard television signal includes auxiliary data during horizontal line intervals within the vertical blanking interval. An example of auxiliary data is closed caption data, which is included in line 21 of field 1. Similarly, digital television signals typically include packets or groups of data words. Each packet represents a particular type of information such as video, audio or auxiliary information.

Whether the system is analog or digital, a video receiver processes both video information and auxiliary information in an input signal to produce an output signal that is suitable for coupling to a display device. Enabling an auxiliary information display feature, such as closed captioning, causes a television receiver to produce an output video signal that includes one signal component representing video information and another signal component representing the auxiliary information. A displayed image produced in response to the output video signal includes a main image region representing the video information component of the output signal and a smaller image region that is inset into the main region of the display. In the case of closed captioning, a caption displayed in the small region provides a visible representation of audio information, such as speech, that is included in the audio program portion of a television program.

Auxiliary data in the form of closed captioning has traditionally been presented in the same language as the primary audio signal. Due to the prohibitive costs of broadcasting a signal containing closed caption data in multiple languages, many broadcasts done in a language different from the language of the primary audio signal typically do not include closed captions or only provide closed captions in the language of the primary audio signal.

### SUMMARY

A system and a method for translating textual data in a media signal includes receiving a media signal containing textual data of a first language, selectively transmitting the media signal to a language translation module, translating the textual data to a second language, and transmitting the translated textual data to a display device to be displayed.

### BRIEF DESCRIPTION OF THE DRAWINGS

The accompanying drawings illustrate various embodiments of the present method and system and are a part of the specification. Together with the following description, the drawings demonstrate and explain the principles of the present method and system. The illustrated embodiments are examples of the present method and system and do not limit the scope thereof.

FIG. 1 illustrates a communications setup configured to receive translated closed captions according to one exemplary embodiment.

FIG. 2 illustrates a simplified flow diagram illustrating a data flow path according to one exemplary embodiment.

FIG. 3 is a flow chart illustrating a method of providing translated closed captions according to one exemplary embodiment.

FIG. 4 illustrates a communications setup including a set-top box configured to receive translated closed captions according to one exemplary embodiment.

FIG. 5 illustrates a simplified flow diagram illustrating a data flow path according to one exemplary embodiment.

FIG. 6 illustrates a communications setup including a home networking device configured to receive translated closed captions.

FIG. 7 illustrates a simplified flow diagram illustrating a data flow path according to one exemplary embodiment.

Throughout the drawings, identical reference numbers designate similar, but not necessarily identical, elements.

### DETAILED DESCRIPTION

The present specification describes a method and a system for dynamically translating and providing user selectable closed captions in receiving devices. More specifically, the present method and system include transmitting a video signal containing encoded closed caption text to a receiving device that is communicatively coupled to a language translation module. The language translation module then decodes the encoded closed caption text, translates the closed caption text to a language specified by a user, and transmits the translated text to a display device where it may be viewed by the user.

In the present specification and in the appended claims, the term “translation” or “language translation” is meant to be understood broadly as any process whereby data or information in one language is converted into a second language. Similarly, the term “language translation module” (LTM) or “language translation engine” is meant to be understood broadly as any hardware or software that is configured to receive data in a first language and then translate that data into a second language. Additionally, the term “closed caption” is meant to be understood broadly as any textual or graphical representation of audio presented as a part of a television, movie, audio, computer, or other presentation. A “set-top box” is meant to be understood broadly as any device that enables a television set to become a user interface to the Internet, enables a television set to receive decoded digital NTSC or digital television (DTV) broadcasts. Similarly, a “home networking device” is any device configured to network electronic components in a structure using any number of network mediums including, but in no way limited to, a structure's pre-existing power lines, infrared (I/R), or radio frequencies (RF). A “head-end insertion device” is any device configured to insert, receive, or translate a signal received by a cable head-end to one or all of the subscribers serviced by the cable provider. A “cable head-end” is a facility or a system at a local cable TV office that originates and communicates cable TV services and/or cable modem services to subscribers.

In the following description, for purposes of explanation, numerous specific details are set forth in order to provide a thorough understanding of the present method and system for dynamically translating and providing user selectable closed captions in receiving devices. It will be apparent, however, to one skilled in the art that the present method may be practiced without these specific details. Reference in the specification to “one embodiment” or “an embodiment” means that a particular feature, structure, or characteristic described in connection with the embodiment is included in at least one embodiment. The appearance of the phrase “in one embodiment” in various places in the specification are not necessarily all referring to the same embodiment.

### Exemplary Overall Structure

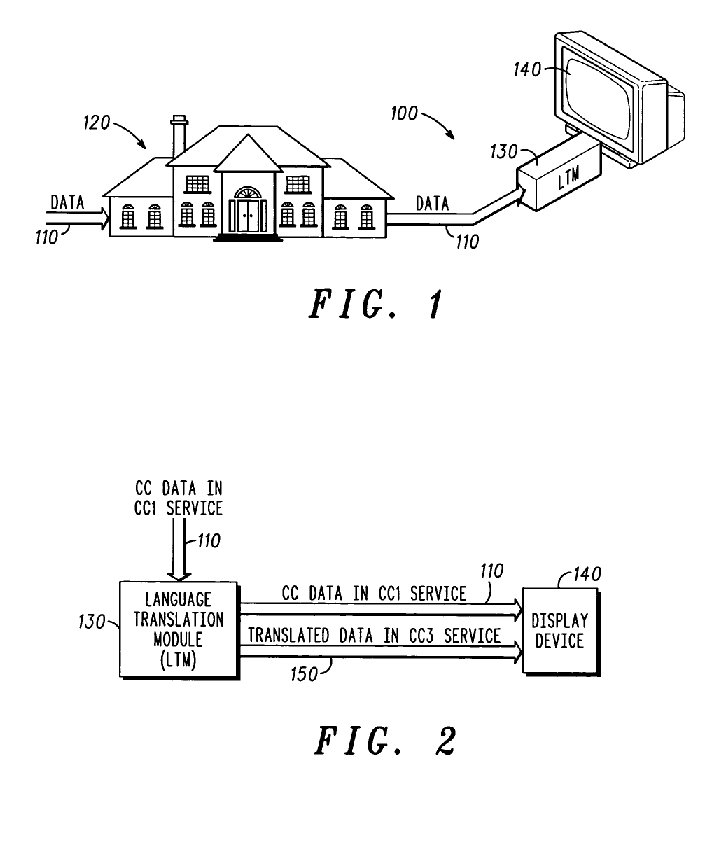

FIG. 1 illustrates an exemplary setup of a system (100) configured to dynamically translate and provide a user with user-selected closed captions in a receiving device. As shown in FIG. 1, an exemplary embodiment may include a user location (120) configured to receive a data signal (110) containing encoded closed caption text. FIG. 1 also illustrates that the user location (120) is communicatively coupled to a display device (140) that is subsequently coupled to a language translation module or engine (130).

The user location (120) configured to receive a data signal (110) illustrated in FIG. 1 may be any location, structure or otherwise, where a user may access and receive a data signal. The user location may include, but is in no way limited to, a home, an office building, a school, a hospital, a church, an automobile, a boat, or any other structure suited to receive a data signal. Moreover, the user location (120) may not be a structure such as in the exemplary case of a wireless signal reception device. The user location (120) may also include a data signal receiver (not shown) configured to receive a data signal (110) at the above-mentioned user location (120). Additionally, the user location (120) may also include a coupling means (not shown) for coupling the user location (120) to the display device (140). The coupling means may include, but is in no way limited to, coaxial cable, optical cable, I/R capabilities, or RF capabilities.

FIG. 1 illustrates a data signal (110) being received by the user location (120). The data signal (110) illustrated in FIG. 1 may be any signal, analog or digital, that may be received at a user location and processed by a display device (140). According to one exemplary embodiment, the data signal (110) includes data representing audio content as well as data representing encoded closed caption text.

The display device (140) receiving the data signal (110) in the exemplary embodiment illustrated in FIG. 1 may be any device configured to present a graphical representation of a received data signal (110). The display device (140) depicted in FIG. 1 may include, but is in no way limited to, a television, a projector, a liquid crystal display (LCD), a computer screen, a personal digital assistant (PDA), a cell phone, or a watch.

As shown in FIG. 1, the display device (140) is communicatively coupled to a language translation module (LTM) or engine (130). The language translation module or engine (130) illustrated in FIG. 1 may be any hardware or software that is configured to receive data in a first language and then translate the data into a second language. In the case of a hardware LTM (130), the LTM may include, but is in no way limited to, a processor for converting data of a first language into a second language, a data storage component that may be accessed by the processor to house a number of language translations, power connections for powering the LTM components, inputs and outputs (I/O), and possibly a heat sink to dissipate heat generated by the processor. In the case of a software LTM (130), the LTM may be located on the hardware of the display device (140) itself as shown in FIG. 1 or it may reside on a separately coupled component.

### Exemplary Implementation and Operation

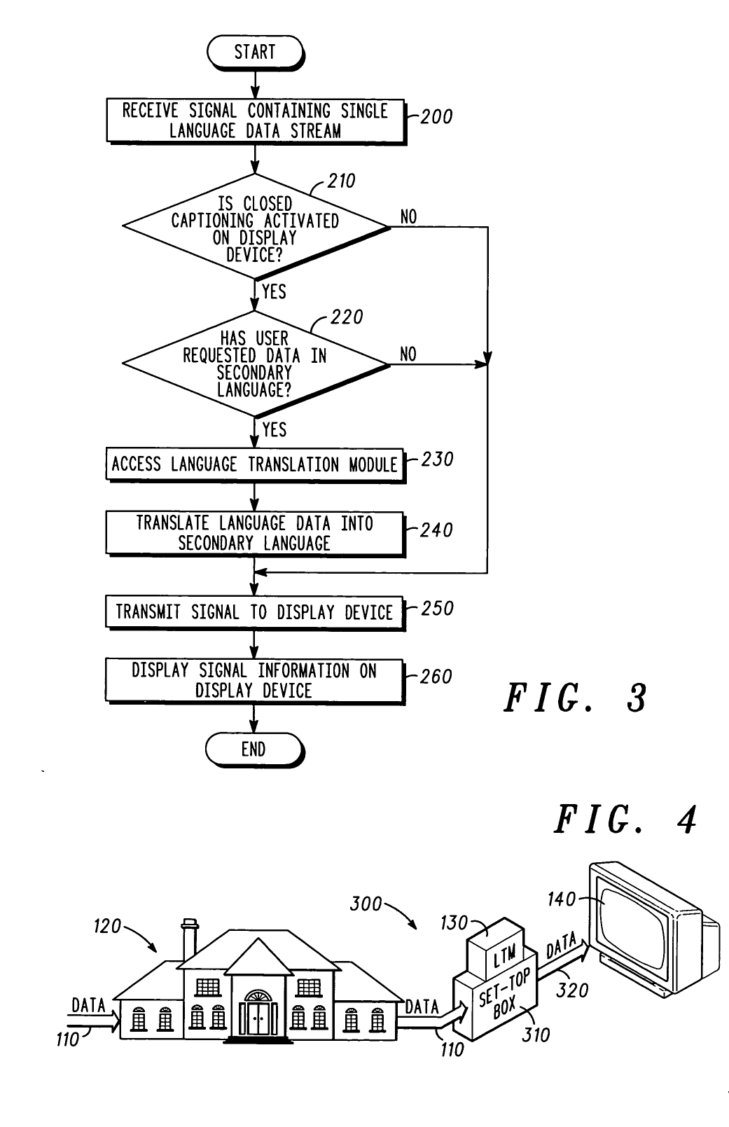

FIG. 3 is a flow chart illustrating a method for dynamically translating and providing user selectable closed captions in reviewing devices. As shown in FIG. 3, one exemplary method for dynamically translating and providing user selectable closed captions in receiving devices begins by receiving a data signal containing a language data stream (step 200). Once the data signal is received, the present system determines whether the user has activated the closed caption option on the display device (step 210). If the closed caption option has not been activated on the display device (NO, step 210), the system transmits the data signal to the display device (140; FIG. 1) without any signal modifications (step 250). If, however, the present system determines that the closed captions option has been activated on the display device (YES, step 210), the system then determines whether the user has requested closed caption data in a secondary language (step 220). If the user has not requested the closed caption data in a secondary language (NO, step 220), the system transmits the signal to the display device (140; FIG. 1) without any signal modifications (step 250). If, however, the user has requested the closed caption data in a secondary language (YES, step 220), the present system accesses the LTM (step 230). Once the LTM has been accessed, the data signal is fed to the LTM where the LTM translates the closed caption data into the requested secondary language (step 240). Once translated, the data signal including the translated closed caption data is transmitted to the display device (step 250) where it is subsequently displayed on the display device (step 260). The above-mentioned method will now be explained in further detail below with reference to FIG. 2.

As shown in FIG. 2, the present method begins by receiving a data signal containing a language data stream (step 200). The data signal received by the present system and method may be received from any source configured to transmit a data signal including, but in no way limited to, a coaxial cable connection, an Internet connection, or a satellite television connection. According to the exemplary embodiment illustrated in FIG. 2, the data signal (110) received by the present system (100; FIG. 1) contains closed caption data. The closed caption data contained in the data signal (110) is likely, though not necessarily, encoded. As shown in FIG. 2, the closed caption data (110) is typically carried by the closed caption 1 service (CC1) according to the national television systems committee (NTSC). The NTSC has designated CC1 and CC3 for synchronized captions (synchronizing the closed captions with the audio signal). Similarly, the advanced television systems committee (ATSC) requires that closed caption information be carried on caption service 1 for digital television (DTV) captioning. While the present exemplary embodiment is shown complying with current United States closed caption requirements, the present system and method may be implemented to comply with any international closed caption requirements

Returning again to FIG. 3, once the data signal has been received, the present system (100; FIG. 1) determines whether the closed caption option has been activated on the display device (step 210). If no closed caption option has been activated on the display device (NO, step 210), there is no need to translate the closed caption signal portion of the data signal. As a result, the data signal is routed directly to the display device (140; FIG. 1) without performing any signal modifications (step 250). If, however, the system determines that the closed caption option has been activated on the display device (YES, step 210), the system then determines whether a user has requested that the closed caption data be translated to a secondary language (step 220). A request for the closed caption data to be translated to a secondary language may be received by the present system (100; FIG. 1) in a number of manners including, but in no way limited to, a request made by an I/R remote on the display device, a request made on a GUI presented by the display device, or a request made by pressing a number of control buttons or knobs located either on the display device (140; FIG. 1) or on the LTM (130; FIG. 1). If no such request has been made to the present system (NO, step 220), then there is no need to translate the closed caption data and the signal is transmitted to the display device without any signal modifications (step 250). If, however, the user has requested the closed caption data in a secondary language (YES, step 220), the present system accesses the LTM (step 230).

Returning again to FIG. 2, once the LTM has been accessed, the data signal (110) is fed to the LTM (130) where the LTM translates the closed caption data into the requested secondary language (step 240; FIG. 3). As shown in FIG. 2, when the LTM (130) receives the original data signal (110) containing the closed caption data to be translated in the CC1 service, the LTM (130) translates the closed caption data into the requested secondary language and prepares it for transmission to the display device. The LTM (130) may translate the closed caption data into the requested secondary language using any language translation methods used in the art including, but in no way limited to, using word association patterns.

Once translated, the data signal including the translated closed caption data is transmitted to the display device (step 250; FIG. 3). As shown in FIG. 2, the original data signal (110) is transmitted to the display device (140) still containing the un-translated closed caption data in the CC1 service or Caption Service 1. Additionally, the translated closed caption data (150) is transmitted to the display device (140) in the CC3 service or Caption Service 3. This exemplary method of transmitting both translated (150) and un-translated (110) closed caption data to the display device allows the user to select either translated or un-translated closed captions depending on which service is displayed by the display device (140). Once the data signal (110, 150) is received by the display device (140), it is subsequently displayed by the display device (step 260).

The above-mentioned method and system for dynamically translating and providing user selectable closed captions in receiving devices allows a user to control the language closed caption data is presented without burdening the broadcaster with the expense of transmitting closed caption data in multiple languages. This ability to translate closed captions may aid the user in learning another language or allowing a user to view the closed captions in their native language.

### Alternative Embodiment

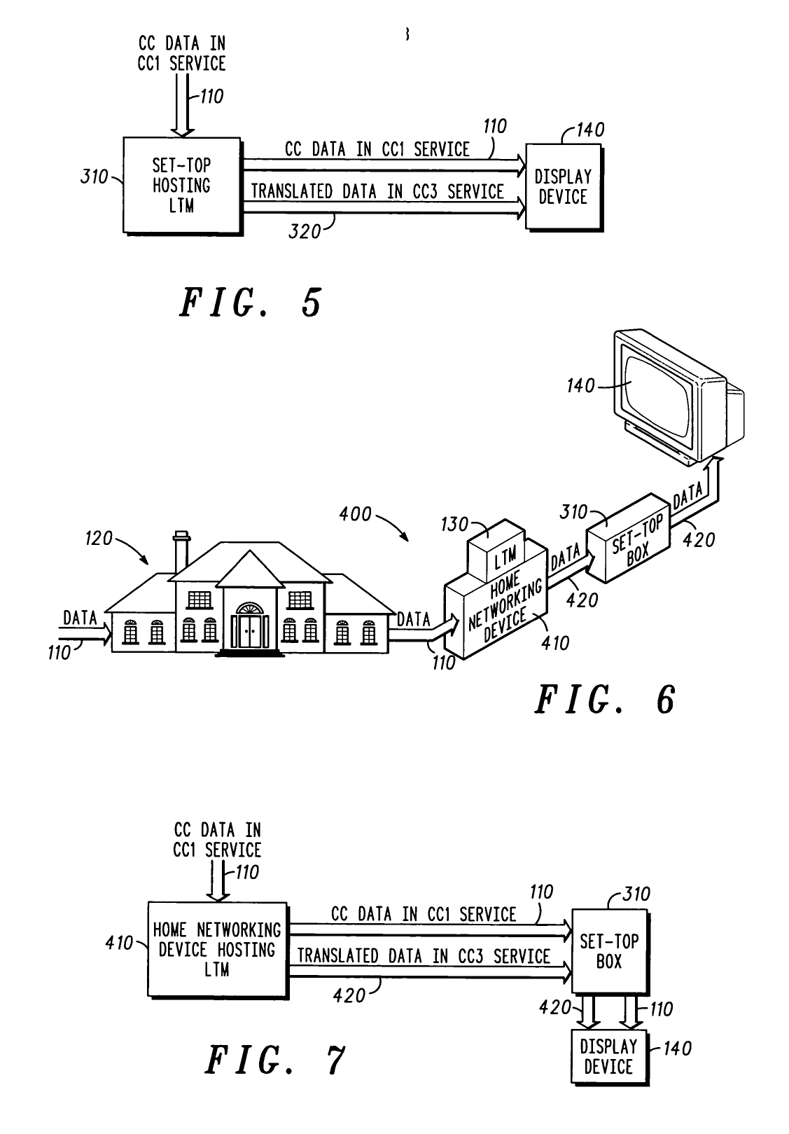

FIG. 4 and FIG. 5 illustrate an alternative embodiment of the present method and system (300) for dynamically translating and providing user selectable closed captions in receiving devices. As shown in FIG. 4, an interactive set-top box (310) may be coupled to the display device (140) according to one exemplary embodiment. A set-top box (310) may be any device that enables a display device (140) to become a user interface to the Internet, enables a television set to receive decoded digital NTSC or digital television (DTV) broadcasts. Additionally, as is shown in FIG. 4, the set-top box (310) may serve as the host to the LTM (130).

As shown in FIG. 5, once a data signal (110) containing closed caption data in the CC1 service or Caption Service 1 is received in the user location (120; FIG. 5), it is transmitted to the set-top hosting the LTM (310). As was previously mentioned above, the LTM may be any hardware or software that is configured to receive data in a first language and then translate the data into a second language. Once in the set-top hosting the LTM (310), the data signal (110) may be translated into a user selected secondary language as was explained previously. Once the translation has been completed, both the original data signal (110) containing the original closed caption data in the CC1 service or Caption Service 1 and the translated closed caption data in the CC3 service or Caption Service 3 (320) may be transmitted to the display device (140) for viewing.

The original data signal (110) and the translated closed caption data (320) may be transmitted to the display device (140) through any number of traditional connection means including, but in no way limited to RCA, optical, I/R, RF, and/or S-video connections. It is also within the scope of the present method and system for the interactive set-top hosting the LTM (310) to be integrated with the display device (140) to form a single functional unit.

The embodiment illustrated in FIG. 4 and FIG. 5 enables the manufacturer of the set top box and/or the signal service provider to provide multi-language closed captions as a subscription option. According to this exemplary embodiment, when the user has not yet ordered multi-lingual closed captions, the LTM remains in a de-activated state. However, when a user has ordered multi-language closed captions, the signal provider enables the LTM through an activation code and provides the LTM with the ability to download a number of databases containing translation libraries for a number of specified languages. Once the user desires to view the closed captions in a secondary language, the LTM including the downloaded language databases may be accessed as explained above allowing for dynamic translation of the audio signal into a user specified secondary language.

Alternatively, FIG. 6 illustrates an exemplary embodiment of a system (400) for dynamically translating and providing user selectable closed captions in receiving devices (140), wherein the system includes a home networking device (510) hosting the LTM (130). When a home networking device is coupled to the set-top box (310) or the display device (140), the LTM being hosted by the home networking device (510) may translate closed caption data and produce closed caption data (520) in a secondary language.

FIG. 7 illustrates a simplified flow diagram illustrating a data flow path according to one exemplary embodiment. As shown in FIG. 7, a data signal (110) containing closed caption data in the CC1 service or Caption Service 1 is received in the user location (120; FIG. 6) and transmitted to the home networking device hosting the LTM (410). Once in the home networking device hosting the LTM (410), the data signal (110) may be translated into a user selected secondary language as was explained previously. Once translated, both the original data signal (110) containing the original closed caption data in the CC1 service or Caption Service 1 and the translated closed caption data in the CC3 service or Caption Service 3 (420) may be transmitted to a set-top box (310) and on to a display device (140). It will be generally understood that the present system and method may be varied by allowing various components in the system to host the LTM (130) including, but in no way limited to, a display device, a set-top box, or a home network device.

A cable head-end insertion device may also host the LTM according to one exemplary embodiment. A cable head-end device is any device configured to insert, receive, or translate a signal received by a cable head-end to one or all of the users serviced by the cable provider. By allowing a cable head-end insertion device to host the LTM, a cable provider may simultaneously supply all of its subscribers with a data signal containing both the original closed captions on the CC1 service or Caption Service 1 and translated closed captions on the CC3 service or Caption Service 3. According to this exemplary embodiment, the cable service provider may provide translated closed captions in the second most predominant language spoken in the area thereby catering to the linguistic needs of a larger portion of their customers. Similarly, any broadcaster of a data signal may host an LTM, enabling them to provide translated data to their customers.

In conclusion, the present method and system for dynamically translating and providing user selectable closed captions in receiving devices, in its various embodiments, allows for the translation of closed caption data from one language to a second language without burdening the signal provider. Specifically, the present system and method provides a language translation module in a user device that is capable of dynamically translating a signal containing closed caption data into various user specified languages.

The preceding description has been presented only to illustrate and describe the present method and system. It is not intended to be exhaustive or to limit the present method and system to any precise form disclosed. Many modifications and variations are possible in light of the above teaching.

The foregoing embodiments were chosen and described in order to illustrate principles of the method and system as well as some practical applications. The preceding description enables others skilled in the art to utilize the method and system in various embodiments and with various modifications as are suited to the particular use contemplated. It is intended that the scope of the method and system be defined by the following claims.

1. A system for translating textual data in a media signal comprising:
a signal receiver;
a display device communicatively coupled to said signal receiver; and
a language translation module communicatively coupled to said display device or said signal receiver;
wherein said language translation module is configured to selectively translate textual data of a first language into a second language.

2. The system of claim 1, wherein said language translation module comprises software.

3. The system of claim 1, wherein said language translation module comprises hardware.

4. The system of claim 1, wherein said display device comprises one of a television, a projector, a personal digital assistant, a cellular phone, or a digital watch.

5. The system of claim 1, wherein said display device hosts said language translation module.

6. The system of claim 1, wherein said receiver comprises one of a set-top box or a home network device.

7. The system of claim 6, wherein said receiver hosts said language translation module.

8. The system of claim 1, further comprising a head-end insertion device communicatively coupled to said receiver.

9. The system of claim 8, wherein said head-end insertion device hosts said language translation module.

10. The system of claim 1, wherein said textual data comprises closed captions.

11. The system of claim 1, wherein said language translation module is configured to be selectively activated by a media service provider.

12. A system for translating textual data in a media signal comprising:
receiving means for receiving said media signal;
display means for displaying a media signal communicatively coupled to said receiving means; and
translation means for selectively translating textual data from a first language to a second language communicatively coupled to said display means or said receiving means.

13. The system of claim 12, wherein said receiving means hosts said translation means.

14. The system of claim 12, wherein said display means hosts said translation means.

15. The system of claim 12, wherein said translation means is configured to be selectively activated by a media service provider.

16. A method for translating textual data in a media signal comprising
receiving a media signal containing textual data of a first language;
selectively transmitting said media signal to a language translation module;
translating said textual data to a second language; and
transmitting said translated textual data to a display device.

17. The method of claim 16, wherein said receiving a media signal further comprises receiving said media signal at a user location.

18. The method of claim 16, wherein said selectively transmitting said media signal further comprises:
receiving a translation request from a user;
activating said language translation module; and
transmitting said textual data to said activated language translation module.

19. The method of claim 18, wherein said selectively transmitting said media signal further comprises:
receiving a language request from said user; and
directing said language translation module to translate said textual data to said requested language.

20. The method of claim 19, wherein said textual data comprises closed captions.

21. The method of claim 16, further comprising selectively enabling said language translation module for subscribers only.

22. A processor readable carrier including processor instructions that instruct a processor to perform the steps of:
receiving a media data stream containing textual data of a first language;
translating said textual data to a second language; and
transmitting said translated textual data to a display device.

23. The processor readable carrier of claim 22, wherein said translating said textual data to a second language comprises:
receiving a language request;
accessing a database corresponding to said language request; and
translating said textual data to said second language using said database.

24. The processor readable carrier of claim 22, wherein said processor instructions further instruct a processor to perform the step of restricting use of said processor until said processor is activated by a media provider.
